(19) United States
(12) Patent Application Publication
(10) Pub. No.: US 2016/0126509 A1
(43) Pub. Date: May 5, 2016

(54) PLASMA COATING FOR CORROSION PROTECTION OF LIGHT-METAL COMPONENTS IN BATTERY FABRICATION

(71) Applicant: GM GLOBAL TECHNOLOGY OPERATIONS LLC, DETROIT, MI (US)

(72) Inventor: Xiaohong Q. Gayden, West Bloomfield, MI (US)

(21) Appl. No.: 14/895,282

(22) PCT Filed: Jun. 4, 2013
(86) PCT No.: PCT/CN2013/076700

§ 371 Date: Dec. 2, 2015

(51) Int. Cl. H01M 2/02; H01M 10/0587; H01M 10/0525

(52) U.S. Cl. CPC H01M 2/024; H01M 10/0525; H01M 10/0587; H01M 2220/20

(57) ABSTRACT

A method is disclosed for making a lithium-ion electrochemical cell comprising elements of the lithium-ion electrochemical cell contained within an aluminum alloy or magnesium alloy single-cell container. External surfaces of the container are coated for resistance to water-based corrosion. Rolled or folded layers of anode, cathode, and separator elements of the lithium-ion cell are placed in the aluminum or magnesium alloy container. And, with the placed elements of the lithium-ion cell in the container, and during one or more following steps of a manufacturing assembly process of the lithium-ion cell, an atmospheric pressure plasma stream, initially comprising hexamethyldisiloxane, is applied to external surfaces of the aluminum alloy or magnesium alloy container to form a silicone polymer coating on the surfaces that protects the container from water-based corrosion. The method is useful in forming batteries for automotive vehicles exposed to salt water environments.

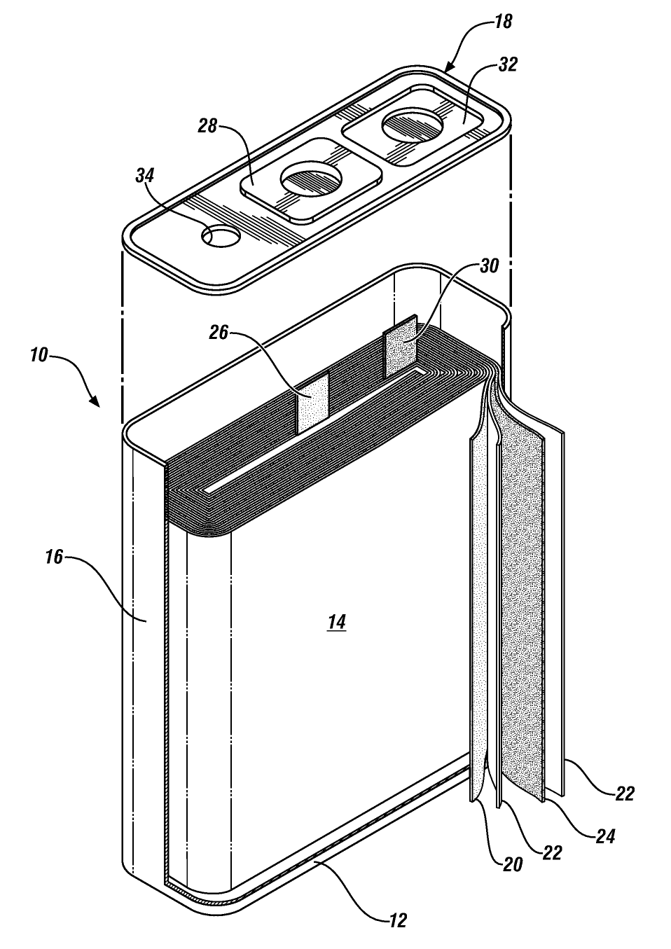

### TECHNICAL FIELD

This invention pertains to the coating of prismatic aluminum or magnesium containers for lithium-ion battery cell materials to protect the light-weight metal from salt water corrosion and to provide electrical insulation between touching containers when they get wet in service. More specifically, a coating material and an atmospheric plasma coating process is provided that may be used to coat the aluminum or magnesium containers in an ambient atmosphere and at a relatively low temperature after they have been filled with their heat-sensitive electrode and electrolyte constituents. The practice of this invention is particularly useful for lithium-ion battery assemblies used on automotive vehicles or other applications in which the light-metal battery containers may be exposed to water-containing corrosive salts or the like.

### BACKGROUND OF THE INVENTION

Assemblies of lithium-ion battery cells are finding increasing applications in providing motive power in automotive vehicles. Each cell of the battery is capable of providing an electrical potential of about three to four volts and a direct electrical current based on the composition and mass of the electrode materials in the cell. The cell is capable of being discharged and re-charged over many cycles. A battery is assembled for an application by combining a suitable number of individual cells in a combination of electrical parallel and series connections to satisfy voltage and current requirements for a specified electric motor. In a lithium-ion battery application for an electrically powered vehicle, the assembled battery may, for example, comprise up to three hundred individually packaged cells that are electrically interconnected to provide forty to four hundred volts and sufficient electrical power to an electrical traction motor to drive a vehicle. The direct current produced by the battery may be converted into an alternating current for more efficient motor operation.

The batteries may be used as the sole motive power source for electric motor driven electric vehicles or as a contributing power source in various types of hybrid vehicles, powered by a combination of an electric motor(s) and hydrocarbon-fueled engine. In a desire to reduce power consumption of all types, there is a continuing desire to reduce the mass of all components of a vehicle, including the mass of the lithium-ion battery.

Lithium-ion batteries for powering automotive vehicles are typically assembled using cans of individual cells. That is, each cell has its own can, enclosing the material elements of a lithium-ion cell with electrically conductive electrode tabs (terminals) extending from each cell container for interconnection with the electrode tabs of another cell or cells. A number of cell cans, for example twelve or twenty-four cell cans, are often grouped and interconnected as a “module”. A number of modules, or the like, are assembled into “packs” of a desired voltage and current producing capability. The shapes of the cell cans are often prismatic, with six rectangular sides and bases, for assembly and support of the modules. The cans add weight to the assembled battery and to the vehicle that the battery serves.

The material of the cans must provide strength for the assembly and containment of the cell components, and the cans must enable cooling of the battery cells because the electrochemical cells produce considerable heat in their use. Further, in automotive vehicle applications, the lithium-ion battery assembly is often located low in the vehicle body structure where it may be exposed to external corrosive materials from road surfaces. Previously, the cans have been made of steel for strength, heat transfer, and resistance to salt water. But steel is relatively heavy. There is a need to adapt lighter metals for use in the assembly of lithium-ion battery cells intended for automotive applications.

### SUMMARY OF THE INVENTION

In accordance with practices of this invention, a suitable aluminum alloy or magnesium alloy material is formed into a suitable thin-wall container shape(s) for insertion of the elements of a lithium-ion cell. As stated, the shapes of the containers are often prismatic and they are called cans. The cans are typically formed with a removed (or removable) side (or top) so that preformed electrode materials and separator materials may be placed in an open-side can. Typically a multi-step procedure is involved in the placement of the electrode materials, separators, and the electrolyte in the can, the welding of electrode tabs to terminals on the can for interconnection with other cans, and the like, as will be described in more detail below in this specification. But, in accordance with this invention, a silicone polymer-containing coating is applied to outside surfaces of the can (and optionally to inside surfaces) to protect the light weight aluminum or magnesium from salt water or other corrosive environmental materials.

The coating process uses hexamethyldisiloxane (HMDSO) as the starting material and it is applied to surfaces of the light-metal can by a low temperature atmospheric plasma process. The liquid HMDSO is delivered to a plasma nozzle (commercially available) in which it is vaporized in an air-plasma stream and directed against surfaces of the aluminum or magnesium can with its lithium-ion cell material contents. Preferably, the material is delivered through the plasma nozzle onto all external surfaces of the can to form a coextensive coating of polymerized hexamethyldisiloxane, typically a silicone polymer. A coating thickness of about 0.1 to about one to about three micrometers is generally suitable to protect the light-metal can material from corrosive elements encountered in vehicle operation. The coating is hydrophobic to shield the cell can surfaces from ambient water and also provides an electrical insulation layer on touching cell can surfaces to electrically isolate them, especially in the presence of water.

An advantage of the selected coating material and atmospheric plasma coating process is that the protective coating may be robotically applied (for example) to the aluminum or magnesium can surface at any of several different steps or locations in a manufacturing line in which lithium-ion cell elements are being placed in the can, or electrode connections are being made with terminals on the can, or the electrolyte is being inserted into the can, or upon can closure, cell activation, can sealing, cell can testing, or other processing of the lithium-ion cell can that is being preformed. A durable hydrophobic, silicone-type polymer coating may be applied to surfaces of the light metal can as the cell is being made and assembled, and the coating may be applied and formed without damage to the vital constituents within the container to which it is applied.

Optionally, inside surfaces of the can may be coated before active elements of the cell are inserted. And the outer surfaces of the can may be coated before the can is delivered to the in-line operation in which the cell elements are assembled in the light-metal can. But it is preferred that outer surfaces be coated at a predetermined step in an in-line type assembly and fabrication of the cell elements and their placement in the light-metal container in which they are to be used in the vehicle battery.

Other objects and advantages of practices of this invention will be apparent from a detailed description of an example of the coating process.

### BRIEF DESCRIPTION OF THE DRAWINGS

The drawing FIGURE is an oblique view of an upstanding aluminum or magnesium can, with a portion of a major side face removed, showing the placement of a roll of layered lithium-ion single-cell elements in the container. After the can is at least partially closed around the cell elements, a coating of polymerized hexamethyldisiloxane is to be applied to each of the outer surfaces of the can using, for example, a computer-controlled, robot-carried nozzle for generating atmospheric pressure plasma of the disiloxane in air and applying a silicone-based coating to surfaces of the light-metal container of the cell materials.

### DESCRIPTION OF PREFERRED EMBODIMENTS

This invention pertains to the manufacture of lithium-ion electrochemical cells for automotive vehicle batteries, particularly for applications in which the battery is to be located on the vehicle where cells (or cans of individual cells) may be exposed to road-splash salty water or other corrosive water compositions. The electrode and separator elements of each cell are usually separately formed, assembled in a suitable cell arrangement, and placed into a pre-formed, partly opened, container body or can. The container cans are often prismatic in shape, with three sets of opposing rectangular sides, so that many cans can be placed together and electrically interconnected to form a vehicle battery. In many applications two to three hundred, substantially identical, single-cells are joined in I or T shaped arrangements and placed on a complementary support tray or plate, carried on a structural member of the vehicle body. And means is provided for water cooling (or water-glycol cooling) of the many cell cans because they generate heat as they are discharged and re-charged. Sometimes the cooling conduits are formed in, or as part of, the cans.

In their location on the vehicle body, the components of the battery members and supports are also exposed to ambient water as the vehicle is driven in many road locations, conditions, and climates. The container bodies have been made of steel, or of a suitable polymer composition (or polymer/metal foil laminate), in order to resist ambient salt water corrosion. But the polymeric materials do not readily conduct heat away from the operating lithium-ion cells, and steel is relatively heavy. The purpose of the subject invention is to adapt light-metal container materials, such as aluminum or aluminum alloys or magnesium or its alloys, for use as can material or container material for individual lithium-ion cells. In accordance with practices of this invention, a silicone polymer coating is formed on surfaces of the light-metal cell can by application of hexamethyldisiloxane using a low temperature, atmospheric plasma spray process. The resulting silicone polymer coating provides good protection against water-based corrosion of the aluminum or magnesium cans making up the battery assembly. In preferred embodiments of the invention, the silicone coating is formed on surfaces of the aluminum or magnesium cans during the in-line assembly/manufacturing process in which electrode-current conductor elements, separator elements, and the electrolyte are being assembled and fitted into their rectangular prismatic containers.

The drawing FIGURE illustrates an exemplary prismatic rectangular cell can 10 with six thin wall sides formed of a suitable aluminum or magnesium alloy. As stated, the shape of the cell can enables it to be placed against like-shaped cell cans in assembling cell modules and the like. In this illustration, the front-facing major vertical side 12 of cell-can 10 is largely broken away to show an assembled roll 14 of the solid elements of the single-cell. The rear major vertical side of cell can 10 is the same size and shape as front-facing side 12, but the rear side is hidden in this view. One vertical edge side 16 is visible and the opposing, like-shaped vertical edge side is hidden. The bottom surface of cell can 10 is hidden and the top side 18 is shown in a position separated and elevated from the sides 12, 16 of cell can 10. In many practices of the invention, the top side 18 of cell can 10 is not joined to the remainder of the cell can structure until assembled roll 14 of the solid elements of the cell has been placed in the open-top can.

In this embodiment of the invention, the assembled roll 14 of thin-layer cell elements consists of a single, relatively long layer of anode elements 20, a long separator layer 22, a single, relatively long layer of cathode elements 24, and another long separator layer 22. The layer of anode elements 20 will have at least one electrical connector tab 26, located along its length, for welding to a terminal 28 on the top side 18 of the can 10. And the layer of cathode elements 24 will have at least one tab 30, suitably located along its length, for connection to a terminal 32 on the top side 18 of cell can 10. The top side 18 of cell can 10 may also have a small opening 34 for injection of a liquid electrolyte into the assembled roll 14 of cell elements after the top side 18 has been welded (or otherwise fixed) to the vertical sides 12, 16 of cell can 10. Opening 34 in top side 18 will be closed after the electrolyte has been added to the other cell elements (roll 14). At one or more stages of the assembly of the elements of the lithium-ion cell in cell can 10, each of the outer surfaces (including visible surfaces 12, 16, and 18) of the cell can 10 will be coated with a layer (e.g., up to about one micrometer or more in thickness) of silicone polymer (or silicone-type polymer) by an atmospheric plasma spray method using hexamethyldisiloxane.

Plasma spray methods and plasma spray nozzles are known and commercially available. In practices of this invention, the initially liquid hexamethyldisiloxane is suitably introduced into and carried in a confined stream of air (for example) into a plasma nozzle in which the air is converted to a plasma stream at atmospheric pressure. The stream of air-based plasma-disiloxane material is progressively directed by the nozzle against surfaces of the aluminum or magnesium cell container. The disiloxane material is deposited on the surfaces of the container, where it polymerizes into a hydrophobic, protective layer of silicone material.

Such plasma nozzles for this application are commercially available and may be carried and used on robot arms, under multi-directional computer control, to coat the many surfaces of each can for a lithium-ion cell module.

The plasma nozzle typically has a metallic tubular housing which provides a flow path of suitable length for receiving the flow of working gas and hexamethyldisiloxane precursor material and for enabling the formation of the plasma stream in an electromagnetic field established within the flow path of the tubular nozzle. The tubular housing terminates in a conically tapered outlet, shaped to direct the shaped plasma stream toward an intended workpiece. An electrically insulating ceramic tube is typically inserted at the inlet of the tubular housing such that it extends along a portion of the flow passage. A stream of a working gas, such as air, and carrying dispersed droplets of hexamethyldisiloxane, is introduced into the inlet of the nozzle. The flow of the air-disiloxane mixture may be caused to swirl turbulently in its flow path by use of a swirl piece with flow openings, also inserted near the inlet end of the nozzle. A linear (pin-like) electrode is placed at the ceramic tube site, along the flow axis of the nozzle at the upstream end of the flow tube. During plasma generation the electrode is powered by a high frequency generator at a frequency of about 50 to 60 kHz (for example) and to a suitable potential of a few kilovolts. The metallic housing of the plasma nozzle is grounded. Thus, an electrical discharge can be generated between the axial pin electrode and the housing.

When the generator voltage is applied, the frequency of the applied voltage and the dielectric properties of the ceramic tube produce a corona discharge at the stream inlet and the electrode. As a result of the corona discharge, an arc discharge from the electrode tip to the housing is formed. This arc discharge is carried by the turbulent flow of the air/hexamethyldisiloxane stream to the outlet of the nozzle. A reactive plasma of the air and disiloxane mixture is formed at a relatively low temperature. A copper nozzle at the outlet of the nozzle is shaped to direct the plasma stream in a suitably confined path against the surfaces of an aluminum or magnesium can for the lithium-ion cell elements. And the plasma nozzle may be carried by a computer-controlled robot to move the plasma stream in multi-directional paths over each surface of the light-metal can to deposit the disiloxane material in a continuous thin layer on the container. The deposited plasma-activated material forms a hydrophobic silicone polymer layer on the container of the lithium-cell elements that provides resistance to water-based corrosion of the can. The coating needs to be free of pinholes or other like defects. The coating must serve to prevent water from contacting the aluminum or magnesium surface and the coating serves as an electrical insulator between cell cans, especially in the presence of water. In general, it is preferred that the coating be applied to each outer surface of the light metal container (and, optionally, to the internal surfaces of the container).

This coating process is preferably conducted at one or more of the processing stages in which layered electrode and separator cell elements have been placed in the cell can and are being connected to it and closed within the can. This plasma coating process may be conducted so as to avoid thermal damage to the heat-sensitive elements of the lithium-ion cell.

The electrode, separator, and electrolyte elements of a specified lithium-ion cell are typically prepared separately and brought together in the manufacturing process by which each cell is made. An illustration of one common such group of cell elements will be described.

The negative electrode (anode, during cell discharge) is often formed by depositing a thin layer of graphite, optionally mixed with conductive carbon black, and a suitable polymeric binder onto a thin foil of copper which serves as the current collector for the negative electrode. The metal current collector may be formed with one or more tabs for making electrical connections with a negative terminal on the cell can. This mixture of bonded, graphitic electrode material is porous, so as to permit suitable infiltration of the non-aqueous electrolyte with its dissolved lithium ions which are intercalated as lithium into the graphitic carbon during activation or charging of the cell. During discharge of the lithium-ion cell, lithium ions flow from the negative electrode material through the electrolyte and into the positive electrode (cathode, during cell discharge). The negative electrode is typically initially formed as a thin sheet layer of less than one millimeter (e.g., a few hundred micrometers) or so in thickness. The original sheet of electrode material may be formed of a size for manufacturing efficiency. Smaller portions, for specific electrode designs, may be cut from the initial sheet for a layered assembly of the electrode material with other elements of cell. Such a layer of negative electrode (or anode material) is illustrated at 20 in the drawing FIGURE.

The positive electrode is also a thin layer of a porous particulate metal oxide composition, which is suitably bonded to a thin foil of aluminum which serves as the current collector for the positive electrode. The aluminum foil may be formed with one or more tabs for connection with a positive terminal on the cell can. During cell discharge, lithium ions flow through the electrolyte and intercalate into the metal oxide composition. Examples of metal oxides for the positive electrode include LiMnO₂, LiMn₂O₄, LiNiO₂, and LiCoO₂. The metal oxide particles are secured as a porous layer to the current collector foil with a suitable organic polymer binder that bonds the particles without inhibiting electrolyte penetration and contact with them. Again, the positive electrode material is formed as a thin layer of material and is illustrated (24) in the drawing FIGURE. And the shape and dimensions of the positive electrode/current collector layer would generally be determined to complement the shape and dimensions of the negative electrode layer, and an interposed separator layer.

A thin porous separator layer is interposed between the negative electrode layer and the positive electrode layer. Two such layers 22 are used in the embodiment illustrated in the drawing FIGURE. In many battery constructions, the separator material is a porous layer of polyethylene or polypropylene. Often the thermoplastic material comprises interbonded fibers of PE or PP. The fiber surfaces of the layer may be coated with particles of alumina, or the like, to enhance the electrical resistance of the separator, while retaining the porosity of the separator for infiltration with liquid electrolyte and transport of lithium ions between the cell electrodes. The separator layer is used to prevent direct electrical contact between the negative and positive electrode layers, and is shaped and sized to serve this function.

The electrolyte for the lithium-ion cell is often a lithium salt dissolved in one or more organic liquid solvents. Examples of salts include lithium hexafluorophosphate (LiPF₆), lithium tetrafluoroborate (LiBF₄), lithium perchlorate (LiClO₄), lithium hexafluoroarsenate (LiAsF₆), and lithium trifluoroethanesulfonimide. Some examples of solvents that may be used to dissolve the electrolyte salt include ethylene carbonate, dimethyl carbonate, methylethyl carbonate, propylene carbonate. There are other lithium salts that may be used and other solvents. But a combination of lithium salt and solvent is selected for providing suitable mobility and transport of lithium ions in the operation of the cell. The electrolyte is carefully dispersed into and between closely spaced layers of the electrode elements and separator layers. The electrolyte is not illustrated in the drawing FIGURE because it is difficult to illustrate between tightly rolled layers and because, in many embodiments, it has not been inserted with the other electrode materials until the top surface 18 has been welded onto the remainder to the cell can.

Obviously, lithium-ion electrochemical cells may be formed using many different shapes and sizes of the negative and positive electrodes to serve a specific power providing function. In many embodiments, the shape of the can or container may be modified in some respect to accommodate the flow of air or a liquid coolant into heat transfer contact with one or more surfaces of the can, but not with the contained elements of the lithium-ion cell. The coolant is often water or a water-glycol mixture. In other embodiments, other structural coolant passages are formed and assembled against surfaces of a pack of cell modules.

In accordance with preferred practices of this invention, a large number of individual lithium-ion cells are formed of like or complementary shapes and sizes, with each cell in a suitable can or container. Each cell can or container has at least one external terminal for each of the negative electrode and the positive electrode. As stated, it is preferred that each cell can have a rectangular shape to easily permit many cans being stacked in a packed structure to form a specified battery or portion of a battery. Appropriate electrical connections are made between the terminals of adjoining cell-cans in order to provide a desired or specified voltage and current output potential for an assembled battery structure. In accordance with this invention, the cans containing the cell elements are formed of aluminum or magnesium (or their alloys) and the external surfaces (at least) are coated with a silicone polymer at an appropriate stage, such as (i) after the loading of the solid, layered, cell elements into the can, (ii) the welding of electrode current collector tabs to a can member or surface, (iii) the injection or loading of the electrolyte into the cans and into (onto) the elements of the caned cell, and/or (iv) the formation of the cell or the sealing of the can. Preferably, liquid hexamethyldisiloxane is dispersed in an atmospheric air plasma stream and applied to surfaces of the can at one or more of these stages during filling of the cell elements into a previously formed can member, closure of the can container, and testing and acceptance of the cell. The coating self-cures as a thin protective silicone polymer layer (up to about one micrometer or more in thickness) on exposed surfaces of the cell container.

Reference is further made to the drawing FIGURE in the following description of the preparation of the cell elements, the loading of the aluminum or magnesium alloy can, and the application of the protective silicone coating onto surfaces of the can.

In this exemplary illustration, strips of anode material (aka negative electrode material, 20 in drawing FIGURE), cathode material (positive electrode, 24), and separator material (22) are delivered in parallel flow paths for the assembly of these solid cell elements into overlying layers for rolling or folding (roll 14) and placing into a suitably sized light-metal can 10, also carried to the assembly site. The respective thin strip electrode elements and separator thin strip element are generally rectangular in shape and have been trimmed to their respective lengths and widths for their assembly and placement in the aluminum or magnesium can. One or more thin metal electrode tabs have been formed or placed in or on the metal foil current collector foil of each electrode layer (e.g., 26, 30 in drawing FIGURE). A four layer assembly may be formed with an anode layer, a separator layer, a cathode layer, and a second separator layer assembly as illustrated (at 14) in the drawing FIGURE. In other embodiments, five layer assemblies are prepared an anode-separator-cathode-separator-anode arrangement or with a cathode-separator- anode-separator- cathode arrangement. These arrangements are usually specified based on the respective material loadings and electrochemical current capacities of the respective electrode material selections. These assembled layers are then rolled or folded so as to be placed in the intended opened aluminum or magnesium can. Typically a side or a top or bottom of the can structure is removed (or not yet engaged), providing a suitable opening for insertion of the cell elements. In the rolling, folding, or other shaping of the layer of cell elements, the electrical connector tab or tabs for each electrode is carefully aligned for insertion in or attachment to any electrical terminal members on the can. In the drawing FIGURE, both terminals (28, 32 are located at the same surface (top surface 18) of the metal container 10.

In many assembly practices of lithium-ion cells the dry elements are placed in their container with suitable electrical connections between the electrode elements and the positive electrode and negative electrode terminals on the can. For example, the welded connections may be made to terminals on a free-standing top surface of the can. When the elements are placed in the can, the top-side may then be welded to vertical sides of the cell can. The can is, for example, thus closed and suitably sealed around the enclosed elements. If it is convenient in the in-line assembly process for lithium-ion cells, the plasma coating may now be applied to each of the external surfaces of the metal can. But there are further stages in the assembly process and further opportunities for the application of the atmospheric plasma coating.

Often a small opening (e.g., 34 in top side 18) is provided in the cell can for the insertion of the non-aqueous electrolyte into the dry volume within the can around the placed cell members so as to permeate the pores of the respective electrode materials and the pores of the separator layer. The electrolyte insertion opening is then closed. Depending on an overall assembly strategy, the coating of the outside surfaces of the light metal container may be done following the insertion of the liquid electrolyte.

The cell may now be activated by applying an electrical potential between its terminals to intercalate lithium ions into the anode material (first charging cycle). The cell may then be partially discharged through a suitable external resistance to further the activation of the cell elements. This charging-discharging practice may be repeated a few times to complete cell module activation and “age” the active elements of the cell. Atmospheric plasma coating using hexamethyldisiloxane may be performed during or after such activation procedures. The cell can is now ready for further assembly with a specified number of other, like-prepared and coated cell cans.

It is also understood that a collection of coated lithium-ion cells will eventually be placed on a suitable tray or other support structure to form one of the battery modules in an automotive battery pack. Such a tray or other support structure may also be coated with a film of silicone polymer by the subject process.

Practices of the invention have been illustrated by use of specific examples. However, it is not intended that the scope of the invention be limited by the illustrations.

1. A method of preparing surfaces of an aluminum alloy or magnesium alloy container for resistance to water-based corrosion when the container will be employed to contain lithium-ion cell elements, the container being sized and shaped for receiving the anode, cathode, separator, and electrolyte elements of a single lithium-ion electrochemical cell which is to be placed on an automotive vehicle and exposed to ambient water in use of the vehicle; the method comprising:
placing at least a portion of the elements of the lithium-ion cell in the aluminum alloy or magnesium alloy container as a step of a manufacturing assembly process of the lithium-ion cell; and, with the placed elements of the lithium-ion cell in the container,
applying an atmospheric plasma stream initially comprising hexamethyldisiloxane to external surfaces of the lithium-ion cell element-containing aluminum alloy or magnesium alloy container so as to form a silicone polymer coating layer on the surfaces that is resistant to water-based corrosion of the aluminum or magnesium alloy of the container surfaces.

2. A method as recited in claim 1 in which the anode, cathode, and separator elements are prepared and assembled in the form of thin layers of the respective elements and the assembled layers are folded or rolled and placed in the container as a step of the manufacturing assembly process; and the plasma stream is then applied to coat at least some surfaces of the container immediately following placement of the assembled layers in the container.

3. A method as recited in claim 2 in which the anode and cathode layers comprise metal tabs for electrical connection to terminals on a surface of the container and the metal tabs are welded to the terminals as a step of the manufacturing assembly process, and the plasma stream is applied to coat at least some surfaces of the container immediately following the welding step.

4. A method as recited in claim 1 in which the container is closed and sealed around the anode, cathode, and separator elements as a step in the manufacturing assembly process; and the plasma stream is applied to coat at least some surfaces of the container immediately following sealing of the container.

5. A method as recited in claim 1 in which the container is closed and sealed around the anode, cathode, and separator elements, and the electrolyte is added to the closed container through a preformed opening as part of the manufacturing assembly process; and the plasma stream is applied to coat at least some of the surfaces of the container following the addition of the electrolyte.

6. A method as recited in claim 1 in which the container contains each of the anode, cathode, separator, and electrolyte elements, and the cell comprising the cell elements has been electrically activated as a step in the manufacturing assembly process; and the plasma stream is applied to coat at least some surfaces of the container immediately following the activation step.

7. A method of making a lithium-ion electrochemical cell in which elements of a single lithium-ion electrochemical cell are contained within an aluminum alloy or magnesium alloy container, the container comprising three sets of opposing rectangular sides and being sized for receiving the anode, cathode, separator, and electrolyte elements of the single lithium-ion electrochemical cell, which container is to be placed on an automotive vehicle and exposed to ambient water in use of the vehicle; the method comprising:
placing at least a portion of the elements of the lithium-ion cell in the aluminum alloy or magnesium alloy container, with at least one open side, as part of a manufacturing assembly process of the lithium-ion cell; and, with the placed elements of the lithium-ion cell in the container,
applying an atmospheric plasma stream, initially comprising hexamethyldisiloxane, to external surfaces of the aluminum alloy or magnesium alloy container so as to form a silicone polymer coating on the surfaces that is resistant to water-based corrosion of the container.

8. A method as recited in claim 7 comprising preparing and assembling the anode, cathode, and separator elements in the form of thin layers of the respective elements and folding or rolling the layers and placing them in the container as a step of the manufacturing assembly process; and with the placed layers of the elements of the lithium-ion cell in the container,
applying the plasma stream initially comprising hexamethyldisiloxane to external surfaces of the aluminum alloy or magnesium alloy container before the container is closed.

9. A method as recited in claim 7 in which the anode and cathode layers comprise metal tabs for electrical connection to terminals on an unattached side of the container, the method further comprising:
welding the metal tabs of an assembled group of the anode, cathode and separator layers of elements to the terminals on the unattached side of the container;
placing the welded combination of the assembled elements in the container with the unattached side closing the container; and, with the welded combination in place,
applying the plasma stream initially comprising hexamethyldisiloxane to external surfaces of the aluminum alloy or magnesium alloy container.

10. A method as recited in claim 7 in which the anode, cathode, and separator elements are placed within the container, the container is closed around the anode, cathode, and separator elements, and the plasma stream is then applied to coat at least some external surfaces of the container immediately following closure of the container.

11. A method as recited in claim 7 in which the container is closed around the anode, cathode, and separator elements and the electrolyte is added to the closed container through a pre-formed opening in a side of the container as a step in the manufacturing assembly process, the opening being subsequently closed, and the plasma stream is applied to coat at least some external surfaces of the container immediately following the addition of the electrolyte and the closure of the opening.

12. A method as recited in claim 7 in which the container contains each of the anode, cathode, separator, and electrolyte elements, the container is closed, and the cell comprising the cell elements has been electrically activated as a step in the manufacturing assembly process, and the plasma stream is applied to coat at least some external surfaces of the container following the activation of the cell elements.
